(19) United States
(12) Patent Application Publication
(10) Pub. No.: US 2009/0276192 A1
(43) Pub. Date: Nov. 5, 2009

(54) Method and Computer Program Product for Visualizing Feature Model Information

(76) Inventors: Uri Avraham, Kfar-Saba (IL); Tal Haham, Misgav (IL); Alan Hartman, Haifa (IL); Julia Rubin, Haifa (IL); Vladimir Shcherbina, Nesher (IL); Yuri Sudorogin, Karmiel (IL)

Correspondence Address: IBM CORPORATION, T.J. WATSON RESEARCH CENTER, P.O. BOX 218, YORKTOWN HEIGHTS, NY, 10598, US

(21) Appl. No.: 12/114,838

(22) Filed: May 5, 2008

(51) Int. Cl. G06F 17/50

(52) U.S. Cl. 703/1

(57) ABSTRACT

A method, a system and a computer program product for visualizing feature model information. The method includes: (i) receiving a feature model that comprises multiple features, an architecture model that comprises multiple architectural elements, and information representative of features implemented by the architecture elements; and (ii) generating a hybrid model that comprises architectural model elements and visual indicators representative of feature model semantics.

### FIELD OF THE INVENTION

The present invention relates to methods and computer program products for visualizing feature model information.

### BACKGROUND OF THE INVENTION

Complex products can be modeled in various manners and in order to satisfy different needs. An architect can use an architectural model of a product that illustrates the implementation details of the product.

Closely related products can form a product line. These product can differ from each other by some features while share other features. A feature model illustrates these features.

The growing complexity of products and product lines should be answered by an effective modeling paradigm that can easily reflect architectural structure and its relation to the product's features.

### SUMMARY

A method, a system and a computer program product for visualizing feature model information. The method includes: (i) receiving a feature model that comprises multiple features, an architecture model that comprises multiple architectural elements, and information representative of features implemented by the architecture elements; and (ii) generating a hybrid model that comprises architectural model elements and visual indicators representative of feature model semantics.

### BRIEF DESCRIPTION OF THE DRAWINGS

The present invention will be understood and appreciated more fully from the following detailed description taken in conjunction with the drawings in which:

FIG. 1 illustrates according to an embodiment of the invention;

FIG. 2 illustrates an example of a feature model;

FIG. 3 provides an example of an architectural model;

FIG. 4 provides an example of a hybrid model, according to an embodiment of the invention; and

FIG. 5 illustrates a system according to an embodiment of the invention.

### DETAILED DESCRIPTION OF THE DRAWINGS

A method, a system, and a computer program product are provided. They facilitate having a feature model as well as a hybrid model. Additional information is included in the hybrid model while the feature module is left unchanged thus can remain relatively simple and easy to manage while a hybrid model includes an architectural model and visual indicators that represent feature model semantics.

The hybrid model can be generated by adding the visual indicators to an existing architectural model.

The hybrid model provides a clear picture of the product line variability. This allows the architect to distinguish between mandatory and optional architectural elements, observe alternative, and mutually inclusive architectural elements. This also enables the architect to adjust the architecture accordingly, design test cases, decide and control system resources and more.

A feature model can include multiple features. Every feature has a type. Samples of feature types include mandatory feature, alternative feature, a feature that is included in a group, a group's default feature, and the like. Different features of a feature model can be related to each other. A relationship between one feature and at least one other feature of the same feature model is referred to as a feature relationship.

Feature model semantics define feature types and feature relationships. Examples of feature types are mandatory, optional, alternative, default, mutually inclusion, inclusion in a group, and the like. Accordingly, a feature can be a mandatory feature, an optional feature, an alternative feature, included in a mutually inclusive group of features, included in a group of features, included in a group of optional features, and the like.

A feature relationship can be expressed as a relationship between multiple features. If, for example, a product can be characterized by one out of two features then these features can be defined as alternative features. This feature relationship can be expressed by the relationship between the features—one feature is an alternative to the other feature. Another manner of expression can include defining a product as including either one feature or the other.

A hybrid model includes architectural model elements and feature model semantics. The feature model semantics is represented by visual indicators. These visual indicators can indicate a feature related type of an architectural model element or a feature relationship that is associated with architectural model elements.

A type of an architectural model element can be responsive to the type of feature that is implemented (is being realized) by the architectural model element. For example, an architectural model element that realizes a mandatory feature is a mandatory architectural element.

A type of an architectural model element can be responsive to the functionality of that architectural model element.

A feature relationship can be associated with different architectural model elements if each of these architectural model elements is associated with a corresponding feature and there is a feature relationship between these corresponding features. This can be illustrated by the following example. It is assumed that: (i) a microwave oven product line can include a microwave oven that provides three level heating and another microwave oven that provides ten level heating—they belong to an alternative group (ii) A three level heating element can realize the three level heating feature while the ten level heating element can realize the ten level heating feature. Given these assumptions the three level heating element is regarded as an alternative architectural model element to the ten level heating element. Accordingly, a feature relationship (in this case alternative features) exists between the mentioned above heating elements.

When the hybrid model is displayed architectural model elements are marked with the features they realize. Based on the element marking and the feature model, the hybrid model elements are visualized so that: (i) an architectural model element that implements a mandatory feature is visualized as a mandatory architectural model element; (ii) an architectural model element that implements an optional feature is visualized as a optional architectural model element; (iii) architectural model elements that belong to the same feature group are marked as belonging to the same group; (iv) an architectural model element that implements a feature that is classified to be a default feature of its feature group, is visualized as a default architectural model element.

According to an embodiment of the invention the type of group (alternative, selective, mutual inclusive, and the like) is also visualized.

A hybrid model is stored at a tangible memory unit. It can be outputted (printed, displayed, transmitted) to a user or a user device in various manners. A hybrid model includes one or more visual indicators that represent visual model semantics.

The visual indicator can be a number, text, a symbol, an icon, a shape, a color, a texture, a style (or text), or a combination thereof. For example, members of a certain group can be surrounded by an enclosing shape (such as but not limited to a box), the color of the enclosing shape can indicate the type of the group. Yet for another example, a certain symbol or text can be displayed near (or inside) members of the same group. Yet for a further example a visual indicator (such as but not limited to an arrow) can link between architectural elements so as to emphasize that these architectural model elements are associated to each other.

It is noted that feature model can include hierarchical model groups and that the hybrid model can display only one or more hierarchical levels. The inclusion of partial information can be determined by a user. At the basic level—only low-level groups and individual features (optional and mandatory) are visualized. Each additional visualization level marks elements that are associated with next hierarchal level of features group in the feature model.

Alternatively, a hybrid model can be generated based upon feature model information and architectural model information but can have a format that is not based upon the format of the architectural model.

The hybrid model can be automatically generated for at least one sub-tree of features in the feature model. The mentioned below methods can be executed by one or more computers.

The hybrid model can be generated by a tangible computer that includes a processor and a memory unit.

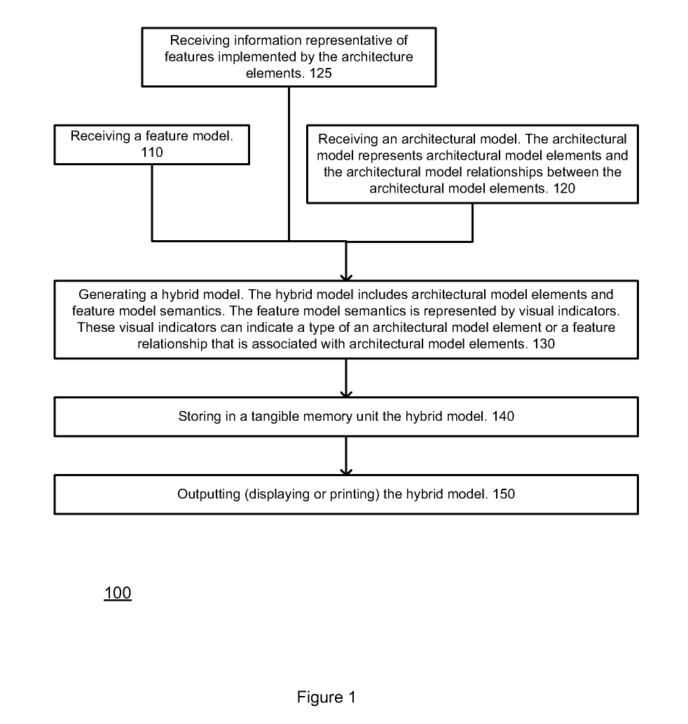

FIG. 1 illustrates method 100 according to an embodiment of the invention.

Method 100 starts by stages 110, 120 and 125.

Stage 110 includes receiving a feature model.

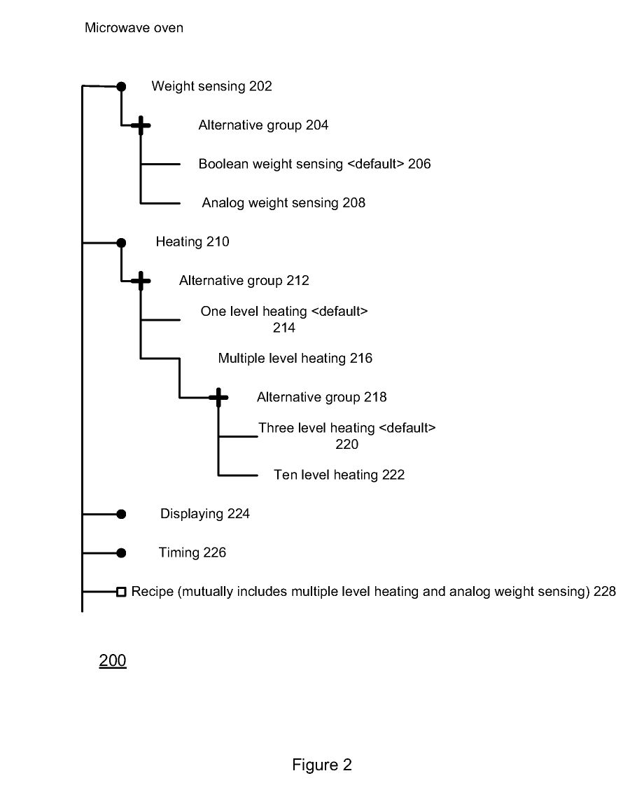

FIG. 2 generates an example of feature model 200. Feature model 200 is a tree of features of a microwave oven product line.

Mandatory elements are marked by dots (.), optional elements are marked by hollow squares, alternative groups are marked by a “+” symbol and default architectural model elements are marked by a “<default>” symbol.

Feature model 200 includes mandatory features such as weight sensing 202, heating 210, displaying 224 and timing 226. The feature model includes the optional feature recipe 228.

Weight sensing 202 can be implemented by any member of alternative group 204. Alternative group 204 includes Boolean weight sensing 206 or analog weight sensing 208. Boolean weight sensing 206 is the default feature of alternative group 204.

Heating 210 can be implemented by any member of alternative group 212. Alternative group 212 includes a one level heating 214 (which is the default element) and another alternative group 218. Alternative group 218 includes three level heating 220 (which is the default element of alternative group 218) and ten level heating 222.

Referring back to FIG. 1, stage 110 can include receiving a feature model such as but not limited to feature model 200.

Stage 120 includes receiving an architectural model. The architectural model represents architectural model elements and the architectural model relationships between the architectural model elements.

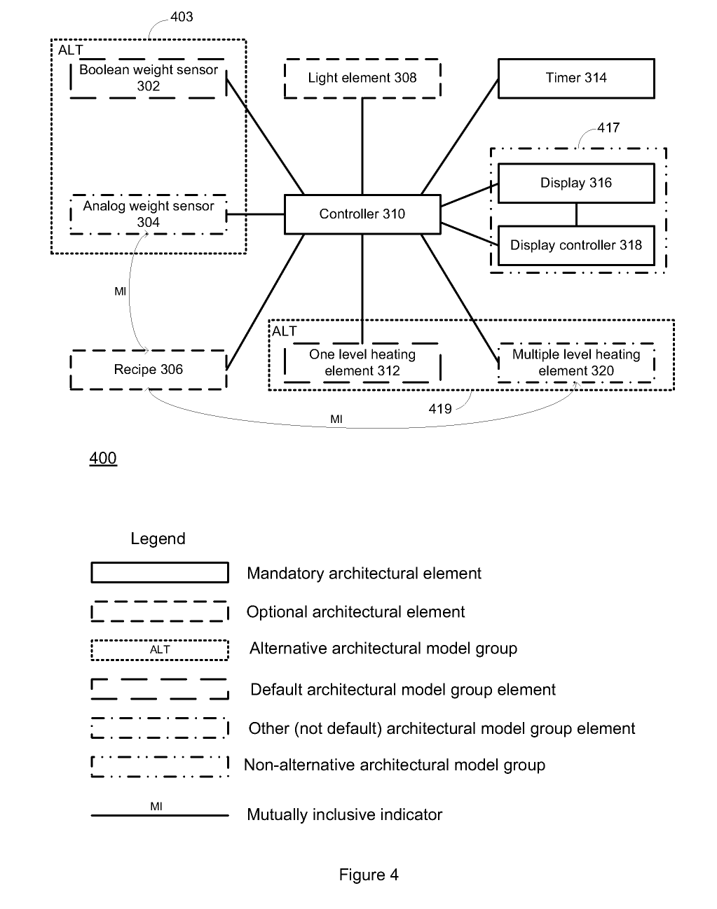

For example, and referring to the example set forth in FIG. 2, in order to enable programming of recipes (denoted recipe 228) the microwave oven should be characterized by an analog weight sensing and multiple level heating—these features are regarded as mutually inclusive. Referring to the example set fourth in FIG. 4 box 306 (recipe) is connected by “MI” arrows (also referred to as mutually inclusive indicator) to boxes 304 (analog weight sensor) and 320 (multiple level heating element). Analog weight sensor 304 and multiple level heating element 320 are also referred to as other (non-default) architectural model group elements. It is noted that FIG. 4 also includes a legend.

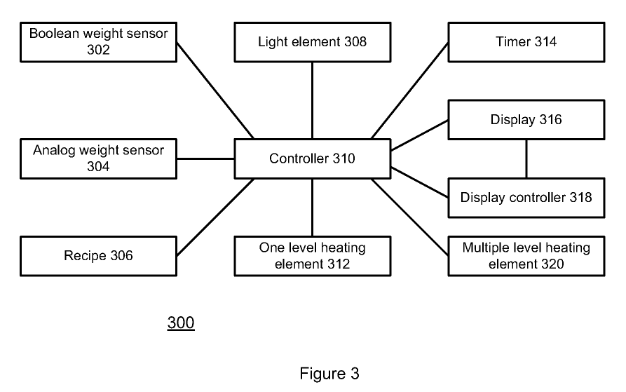

FIG. 3 provides an example of architectural model 300. Architectural model 300 illustrates the architectural model elements that can be included in any microwave oven of a certain microwave product line.

Architectural model 300 includes the following architectural model elements: Boolean weight sensor 302, analog weight sensor 304, recipe module 306, light element 308, controller 310, one level heating element 312, timer 314, display 316, display controller 318 and multiple level heating element 320.

Controller 310 is linked to all other architectural model elements 302, 304, 306, 308, 312, 314, 316, 318 and 320. It is noted that multiple level heating element 320 can function as a three level heating element or a ten level heating element.

Architectural model 300 does not illustrate the product line variability, and does not include feature model semantics.

Referring back to FIG. 1, stage 125 includes receiving information representative of features implemented by the architecture elements.

Stages 110, 120 and 125 are followed by stage 130 generating a hybrid model. The hybrid model includes architectural model elements and feature model semantics. The feature model semantics is represented by visual indicators. These visual indicators can indicate a type of an architectural model element or a feature relationship that is associated with architectural model elements.

FIG. 4 provides an example of hybrid model 400, according to an embodiment of the invention.

Hybrid model 400 includes the following architectural model elements: Boolean weight sensor 302, analog weight sensor 304, recipe module 306, light element 308, controller 310, one level heating element 312, timer 314, display 316, display controller 318 and multiple level heating element 320.

Hybrid model 400 illustrates the product line variability. It includes feature model semantics. The feature model semantics are visualized by using visual indicators. For simplicity of explanation color based visual indicators were replaced (in FIG. 4) by black and white indicators.

Boxes 403, 419 and 417 are visual indicators that are indicative of groups of architectural model elements.

A first alternative architectural model group is denoted 403 and includes Boolean weight sensor 302 (that is default architectural model group element) and analog weight sensor 304. The two elements belong to an alternative group since both implement features that are marked as alternative in the feature model.

A second alternative architectural model group is denoted 419 and one level heating element 312 (that is default architectural model group element) and a multiple level heating element 320. The two elements belong to an alternative group since both implement features that are marked as alternative in the feature model.

A third group is denoted 417 (it is also referred to as a non-alternative architectural model group) and includes two elements—display 316 and display controller 318. Both architectural model elements are mandatory. They are grouped since both implement the same feature.

Mandatory architectural elements such as controller 310 and timer 314 are illustrated by a first type of boxes. The architectural elements are marked as mandatory since they implement mandatory features.

Optional architectural element such as light 308 and recipe 306 are illustrated by a second type of boxes. The architectural elements are marked as optional since they implement optional features.

Alternative groups of architectural model elements such as alternative architectural model group 403 and alternative architectural model group 419 are illustrated by a third type of boxes.

Default features such as Boolean weight sensor 302 and one level heating element 312 are illustrated by a fourth type of boxes.

A first “MI” (mutually inclusive) arrow links recipe 306 and analog weight sensor 304 while a second MI arrow links recipe 306 and multiple level heating element 320 to indicate that recipe 306 requires both analog weight sensor 304 and multiple level heating element 320. This information is taken from the feature model.

Stage 130 is followed by stage 140 of storing in a tangible memory unit the hybrid model.

Stage 140 can be followed by stage 150 of outputting (displaying or printing) the hybrid model.

It is noted that stage 140 and 150 can be executed in parallel to each other.

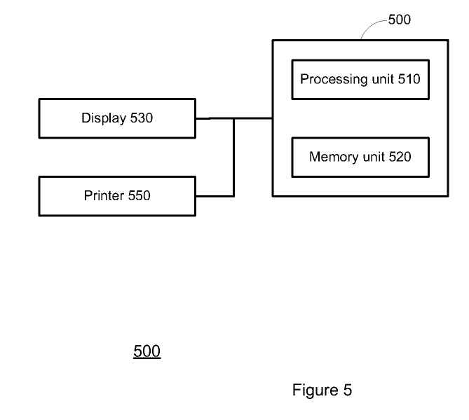

FIG. 5 illustrates system 500 according to an embodiment of the invention. System 500 can execute method 100. System 500 can include processing unit 510 and memory unit 520.

According to an embodiment of the invention memory unit 520 can store a feature model. Processing unit 510 can execute code that causes it to generate a hybrid model that comprises architectural model elements and visual indicators representative of feature model semantics. Memory unit 520 can store the hybrid model but this is not necessarily so and other memory or storage units that are connected to system 500 can store the hybrid model. System 500 can include (or can be connected) to display 530 and additionally or alternatively to printer 550. The hybrid model and especially its visual indicators can be display on display 530 and/or printer by printer 550.

Furthermore, the invention can take the form of a computer program product accessible from a computer-usable or computer-readable medium generating program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can store information that can be read by electronic, magnetic, optical, electromagnetic or infrared based techniques, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which generate temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for visualizing feature model information, the method comprises:
receiving a feature model that comprises multiple features, an architecture model that comprises multiple architectural elements, and information representative of features implemented by the architecture elements; and
generating a hybrid model that comprises architectural model elements and visual indicators representative of feature model semantics.

2. The method according to claim 1 comprising generating a hybrid model that comprises at least one visual indicator selected from a list consisting of: a visual indicator of optional architectural elements, a visual indicator of a mandatory architectural element, and visual indicator of mutually inclusive architectural elements.

3. The method according to claim 1 comprising generating a hybrid model that comprises at least one visual indicator of architectural elements that belong to a group of architectural elements.

4. The method according to claim 3 comprising generating a hybrid model that comprises a visual indicator of architectural elements that belong to a group of architectural elements that is selected from a list consisting of an alternative group of architectural elements, an OR group of architectural elements, and a group of mutually inclusive architectural elements.

5. The method according to claim 3 comprising generating a hybrid model that comprises a visual indicator of a group default architectural element.

6. The method according to claim 3 comprising generating a hybrid model that comprises at least one visual indicator that is representative of feature model semantics.

7. The method according to claim 1 wherein at least one visual indicator represents feature model semantics.

8. The method according to claim 1 comprising generating the hybrid model by adding to an architectural model the visual indicators.

9. A computer program product comprising a computer usable medium including a computer readable program, wherein the computer readable program when executed on a computer causes the computer to: receive a feature model that comprises multiple features, an architecture model that comprises multiple architectural elements, and information representative of features implemented by the architecture elements; and
generate a hybrid model that comprises architectural model elements and visual indicators representative of feature model semantics.

10. The computer program product according to claim 9 that causes the computer to generate a hybrid model that comprises at least one visual indicator selected from a list consisting of: a visual indicator of optional architectural elements, a visual indicator of a mandatory architectural element, and visual indicator of mutually inclusive architectural elements.

11. The computer program product according to claim 9 that causes the computer to generate a hybrid model that comprises at least one visual indicator of architectural elements that belong to a group of architectural elements.

12. The computer program product according to claim 11 that causes the computer to generate a hybrid model that comprises a visual indicator of architectural elements that belong to a group of architectural elements that is selected from a list consisting of an alternative group of architectural elements, an OR group of architectural elements, and a group of mutually inclusive architectural elements.

13. The computer program product according to claim 11 that causes the computer to generate a hybrid model that comprises a visual indicator of a group default architectural element.

14. The computer program product according to claim 9 that causes the computer to generate a hybrid model that comprises at least one visual indicator that is representative of feature model semantics.

15. The computer program product according to claim 9 that causes the computer to generate the hybrid model by adding to an architectural model the visual indicators.

16. A system for visualizing feature model information, the system comprises: a memory unit that is adapted to receive a feature model that comprises multiple features, an architecture model that comprises multiple architectural elements, and information representative of features implemented by the architecture elements; and a processor adapted to generate a hybrid model that comprises architectural model elements and visual indicators representative of feature model semantics.

17. The system according to claim 16 wherein the processor is adapted to generate a hybrid model that comprises at least one visual indicator selected from a list consisting of: a visual indicator of optional architectural elements, a visual indicator of a mandatory architectural element, and visual indicator of mutually inclusive architectural elements.

18. The system according to claim 16 wherein the processor is adapted to generate a hybrid model that comprises at least one visual indicator of architectural elements that belong to a group of architectural elements.

19. The computer program product according to claim 16 that causes the computer to generate a hybrid model that comprises a visual indicator of a group default architectural element.

20. The system according to claim 18 wherein the processor is adapted to generate a hybrid model that comprises at least one visual indicator that is representative of feature model semantics.

21. The system according to claim 18 wherein the processor is adapted to generate the hybrid model by adding to an architectural model the visual indicators.
